(19) United States
(12) Patent Application Publication
(10) Pub. No.: US 2023/0219252 A1
(43) Pub. Date: Jul. 13, 2023

(54) METHOD OF GLUING A WOOD PRODUCT AND A GLUED WOOD PRODUCT

(71) Applicants: Stora Enso OYJ, Helsinki (FI); TECHNISCHE UNIVERSITÄT MÜNCHEN, München (DE)

(72) Inventors: Markus Hirmke, Rossatz-Arnsdorf (AT); Frank Hunger, Augsburg (DE)

(73) Assignee: Stora Enso OYJ, Helsinki (FI)

(21) Appl. No.: 18/000,868

(22) PCT Filed: Jun. 17, 2021
(86) PCT No.: PCT/IB2021/055347

§ 371 Date: Dec. 6, 2022

(30) Foreign Application Priority Data
Jun. 18, 2020 (SE) 2050730-7

(51) Int. Cl. B27M 3/00; B32B 21/13; B32B 3/06; B32B 7/12; B32B 38/00; B32B 37/12; B32B 37/10; E04C 2/12; B27F 1/04; C09J 5/00

(52) U.S. Cl. CPC B27M 3/0053; B32B 21/13; B32B 3/06; B32B 7/12; B32B 38/0004; B32B 37/12; B32B 37/10; B32B 38/164; E04C 2/12; B27F 1/04; C09J 5/00; B32B 2317/16; B32B 2255/08; B32B 2255/26; B32B 2607/00; B32B 2419/06; B32B 2419/00; B32B 2038/166

(57) ABSTRACT

The present invention relates to a method of producing a glued wood product for use in construction, comprising the steps of: providing at least two wooden pieces each piece comprising at least one joining face; creating a groove in at least one of said joining faces where the groove is arranged between a pair of peripheral edges; applying adhesive onto at least one of the joining faces of at least a first of said two wooden pieces; arranging said first wooden piece so that the joining face which comprises the applied adhesive meets a corresponding joining face of said second wooden piece, wherein at least one of said two joining faces comprises said groove; pressing the two joining faces towards each other so that the adhesive is compressed between said two wooden pieces, and maintaining said pressing for a sufficient time to bond the wooden pieces to each other; wherein the applied pressing force is strong enough to force the wood tissue to collapse at a contact area until the pressure force is transmitted primarily through the adhesive, wherein said contact area is defined by the surface area whereat the two joining faces of said wooden pieces contact each other upon being pressed together.

### TECHNICAL FIELD

The present invention relates to a method of producing a glued wood product for use in construction.

### BACKGROUND

Wood joinery is a basic concept in all of woodworking, and the ability to join two pieces of wood together in a solid fashion for instance by gluing is frequently practiced e.g. in construction, carpentry, furniture making, manufacturing of floor and ceiling elements, glulam beams and joists, as well as rib slabs and timber cladding.

A well known way of obtaining a load-bearing structure is by edge gluing boards into a larger surface area. In general, edge gluing of solid timber is done in the following manner. Roundwood logs are processed in a sawmill into squared pieces of wood. The squared pieces of wood (referred to as e.g. lumber, timber, boards, planks, scantlings, etc.) are then typically stick-stacked and dried in a technical drying process to a wood moisture content of about 12-15%. The thus dried pieces are planed in a planing machine in order to make the surfaces, which will be glued afterwards, plane.

In the herewith attached drawings, FIG. 1 schematically illustrates a conventional piece of sawn board 1′, having a flat elongated shape and a longitudinal direction which is substantially parallel with a principal fiber direction of the board. The board 1′ has parallel major faces 1a′, 1b′ and parallel minor faces 1c′, 1d′, where the length L of said major faces exceeds the width W thereof. FIGS. 2a-b illustrates schematically a common way of joining two boards 1′, 2′ by means of edge gluing. As seen herein, an adhesive 4 is applied onto the planed surfaces 1d′, 2c′ (herein also called “joining faces”) whereafter the pieces 1′, 2′ are aligned and pressed together to cure the glue-line 5.

One shortcoming of the existing technique is that excess glue is squeezed out of the glue-line, resulting in “glue-tears” or “glue-scabs” that stick to the surface. This can be problematic, because the glue-scabs are an obstacle for immediate further processing, requiring an extra cleaning step or limiting the choice of adhesives. Some adhesives, e.g. polyurethanes, have a more pronounced tendency to form glue-scabs. Polyurethanes are however commonly used and show some significant advantages in processing.

There is thus a need for more efficient methods of producing glued wood products made from solid timber.

### SUMMARY

It is an object of the present invention to provide an improved method of producing glued wood products made from solid timber, in particular to improve edge-gluing and/or face-gluing of solid boards.

The invention is defined by the appended independent claims. Embodiments are set forth in the appended dependent claims.

According to a first aspect, the present invention relates to a method of producing a glued wood product for use in construction, comprising the steps of: providing at least two wooden pieces each piece comprising at least one joining face; creating a groove in at least one of said joining faces where the groove is arranged between a pair of peripheral edges; applying adhesive onto at least one of the joining faces of at least a first of said two wooden pieces; arranging said first wooden piece so that the joining face which comprises the applied adhesive meets a corresponding joining face of said second wooden piece, wherein at least one of said two joining faces comprises said groove; pressing the two joining faces towards each other so that the adhesive is compressed between said two wooden pieces, and maintaining said pressing for a sufficient time to bond the wooden pieces to each other; wherein the applied pressing force is strong enough to force the wood tissue to collapse at a contact area whereupon the pressure force is transmitted primarily through the adhesive (i.e. subsequent to collapse of wood tissue, the majority of the pressure is acting on the glue), and wherein said contact area is defined by the surface area whereat the two joining faces of said wooden pieces contact each other upon being pressed together.

It is to be understood that a “joining face” herein refers to a face/surface of a piece of wood intended to be joined to a meeting joining face of another piece of wood. A joining face is preferably planar, or at least presents a planar portion.

The skilled person also understands that adhesive may be applied onto one or both of said joining faces of two piece of wood. For instance, the use of a “two-component adhesive system” is conceivable, wherein a glue and a hardener are applied separately on two meeting faces (i.e. glue on one side and hardener on another side). Once pressed together, said adhesive and hardener will react instantly. A two-component adhesive system gives the possibility to have long working time and very short pressing time.

It is also to be understood that a “groove” herein refers to a depression or indentation positioned between raised edges, arranged in the surface of the joining face. A surface comprising said groove will achieve a profile with protruding edges.

It is also to be understood that the expression “corresponding joining face” herein means a surface of a separate piece of wood (where said “piece of wood” may be a board/plank) which is dimensionally matching so that when adjusted and pressed against each other the respective peripheries of the two faces can be aligned.

Thanks to the invention, several advantages are achieved:
instead of planing two surfaces that are to be glued together, the creating of said groove on one or both meeting surfaces leads to the effect of locking the glue in place and prevent it from leaking out at the glue-line;
locking the glue in place by means of said groove will have the effect that the surfaces of the wood pieces will not be contaminated by glue-scabs, and additional processing steps to clean the surfaces can be avoided, which is a cost saving factor;
the overall glue consumption and hence the glue costs are decreased.

Yet another advantage is associated with the feature that, according to the invention, when the pressing power is applied, the wooden cells in the protruding edges collapse and the height is reduced to such an extent that the pressing power becomes effective on the adhesive located in the groove. Hereby, the required pressure will take effect on the adhesive in the bond line and also cause penetration of the adhesive into the surfaces of the assembly components. (The “assembly components” refers to the meeting wooden pieces, e.g. meeting boards or planks.) According to the invention, the applied pressure causes the adhesive to penetrate the surfaces of the first few rows of wood cells adjacent to the groove. Upon curing, the adhesive will act as a mechanical anchor, and a durable joint is produced by physical adsorption and chemical bonding on the porous structure/fibers of the wood tissue.

The result is a strong and durable glue connection between the two pieces of wood, which is a requirement e.g. for load-bearing purposes in wooden constructions. In other words, thanks to the compressed wooden tissue located at the protrusions, the lateral spillage of adhesive is effectively prevented or clearly reduced. At the same time, the required pressure takes effect on the adhesive in the bond line, leading to a strong structure once the adhesive is cured.

According to one aspect of the invention, said wooden pieces are boards sawn from solid wood, each board presenting a flat elongated shape and having a lengthwise longitudinal direction which is substantially parallel with a principal fiber direction of the respective wooden board. Each of said at least two boards comprises major faces and minor faces wherein the length of said major faces exceeds the width of the major faces. Furthermore, in this embodiment said groove is arranged to extend in a longitudinal direction of the board, parallel to its lengthwise direction, and is created on at least one of said faces. According to this aspect, the groove is arranged between a pair of peripheral, longitudinal edges/protrusions. Also, said joining faces correspond to the two faces of each of the respective boards which are arranged to meet each other when adjoining two boards by means of said adhesive.

According to one aspect of the invention, said groove is created on one of said minor faces of at least one of said boards, corresponding to “edge-gluing” technology.

According to another aspect of the invention said groove is created on one of said major faces of at least one of said boards, corresponding to “face-gluing” technology.

According to another aspect of the invention, the adhesive is chosen to be of a type suitable for gluing together solid wood, preferably one of isocyanate, polyvinyl acetate, urethane and polyurethane based glue, or a two-component system (comprising hardener and adhesive) such as melamine-urea-formaldehyde or phenol-resorcin-formaldehyde based adhesives.

According to yet another aspect of the invention, the method comprises subjecting the wooden boards to a drying step prior to the application of adhesive so that said boards after the drying step have a wood moisture content between 6-15% by weight.

According to yet another aspect of the invention, said boards have a wood moisture content of between 15-24% by weight.

According to yet another aspect of the invention, the pressing power is between 0.6-1.5 N/mm². For coniferous wood species the specific pressing power is normally in a range of 0.6-1.0 N/mm² and for hardwood species it is usually significantly higher, to guarantee the penetration of the adhesive into the surfaces of the assembly components.

According to yet another aspect of the invention, the groove has a maximum depth of between 0.1-0.3 mm. According to present standards, the final glue-line in a wooden structure should not exceed 0.3 mm in order to be within the scope of the adhesives to be used.

According to yet another aspect of the invention, said pair of peripheral, edges flanging said groove presents said contact area corresponding to the surface where the two faces of said boards abut and contact each other upon being pressed together, wherein said contact area corresponds to between 5-20% of the total horizontal area of respective face comprising said groove.

The present invention also relates to a glued wood product for use as a wooden construction element, load-bearing timber structures or non-load-bearing timber structures.

The present invention also relates to the use of a glued wood product, obtainable by means of a method according to the present invention, as a construction element for building and/or manufacturing a wall, roof, floor and/or ceiling element. For instance, a wooden product made by means of the method according to the present invention can be used as construction element such as one layer of a multilayer panel.

### BRIEF DESCRIPTION OF THE DRAWINGS

FIG. 1 schematically illustrates a wooden beam according to prior art.

FIGS. 2a-b schematically illustrate the principle of edge-gluing two beams according to prior art.

FIG. 3a schematically illustrates an end portion of a wooden piece according to an exemplary embodiment of the invention.

FIG. 3b is a detailed view according to IIIb of FIG. 3a.

FIGS. 4a-c schematically illustrate consecutive steps according to one example of the method of the invention.

FIGS. 5a-f schematically illustrate consecutive steps according to yet another example of the method of the invention.

FIGS. 6a-b shows an enlarged sectional view of the glue-line of a glued wood product.

FIGS. 7a-d schematically show detailed views of the profile of said peripheral edges according to four different embodiments according to the present invention.

FIGS. 8a-b show photos of edge-glued boards.

### DETAILED DESCRIPTION

It is to be understood that the foregoing general description and the following detailed description are exemplary only, and are not restrictive of any subject matter claimed. Unless otherwise defined, all technical and scientific terms used herein have the same meaning as is commonly understood by a person skilled in the art to which the inventions belong.

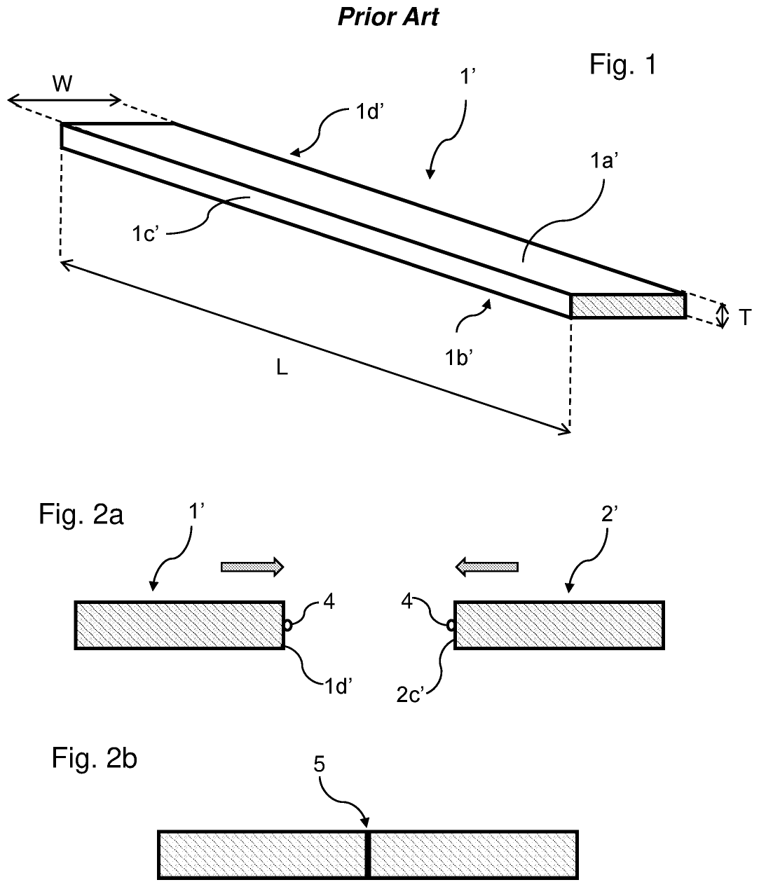

As previously explained, FIG. 1 schematically illustrates a conventional wooden board or plank 1′, which has been sawn out of a roundwood log. As a result, the length L of the board is substantially parallel with a principal fiber direction of the wooden board. The flat elongated board 1′ comprises two parallel major faces 1a′, 1b′ and two parallel minor faces 1c′, 1d′, wherein the length L of said major faces exceeds the width W of the major faces. The board 1′ further has a thickness T which, in turn, is smaller than said width W.

FIGS. 2a-b schematically illustrate an edge-gluing procedure according to prior art, as has been described in the Background section of this application.

As seen in the appended drawings, said wooden piece is here represented by a wooden board 2. However, the skilled person understands that the invention is not to be limited to a “board”, but that other shapes made from solid wood which fulfill the requirements of the claims specified herein are also included in the scope of the invention.

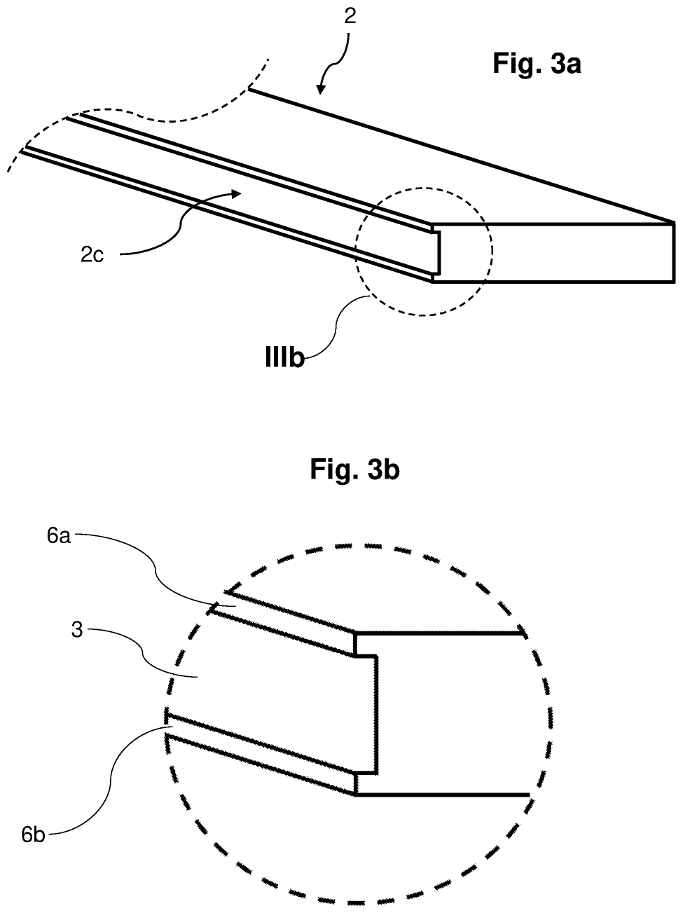

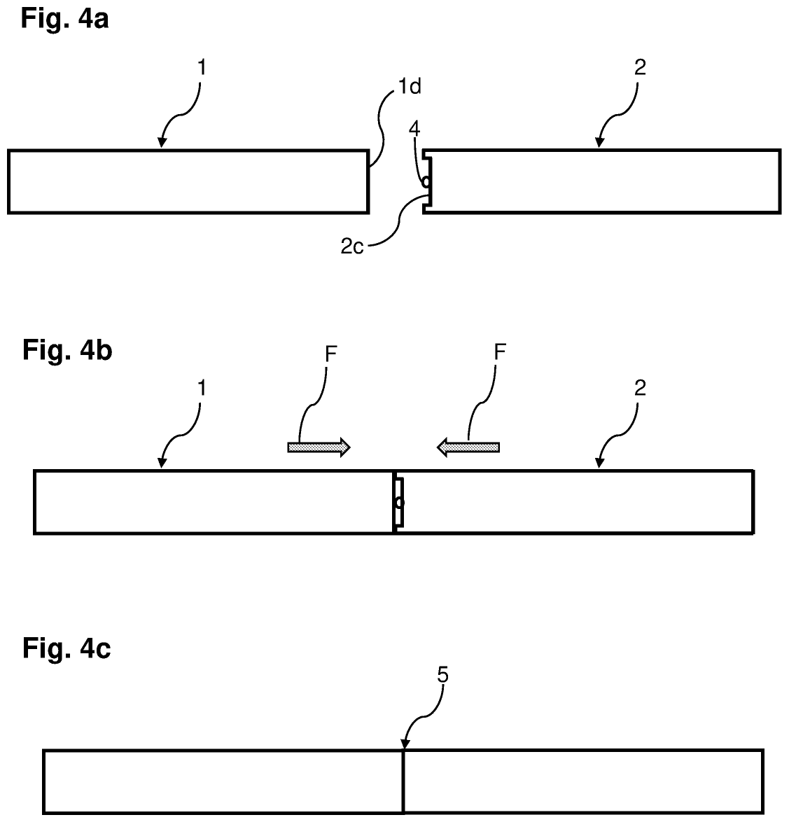

Furthermore, for the sake of convenience, the board shown in FIGS. 3a-b, and also the boards 1, 2 shown in FIGS. 4a-c are herein described essentially in the same terms as used for describing the conventional board in FIG. 1. In other words, the skilled person understands that also the boards 1, 2 that are described when illustrating the inventive concept comprises major and minor faces, as well as having a length L exceeding the width W etc.

Now turning firstly to FIGS. 3a-b, the outline of a wooden piece according to the invention is to be further described. The wooden piece is herein illustrated as a board 2 made from solid wood. FIG. 3 shows an end portion of a board and FIG. 3b is a detailed view according to IIIb in FIG. 3a. One of the minor faces 2c of said board 2 comprises a longitudinal groove 3 arranged between a pair of protruding edges 6a, 6b. This minor face 2c represents a joining face, which is intended for being adjoined to another dimensionally matching joining face of another board by means of a gluing procedure, which is illustrated in a schematic way in FIGS. 4a-c. Herein, a board 2 as described in FIGS. 3a-b is aligned with a meeting board 1 having essentially the same dimensions. An adhesive 4 is applied onto at least one of the two joining faces 1d, 2c. In the current example, adhesive is applied on the board 2 which comprises the groove 3 and at the location of the groove, i.e. between the edges. The boards 1, 2 are arranged so that the joining face 1d of the first board 1 meets the corresponding joining face 2c of the second board 2. As seen in FIG. 4b, the two boards 1, 2 are pressed towards each other with a predetermined pressing force F such that the adhesive 4 is compressed between the two joining faces 1d; 2c at a glueline 5. The peripheral protruding edges 6a, 6b will prevent leakage of adhesive. Said pressure F is maintained for a sufficient time to solidly connecting/joining the boards 1, 2 to each other. Furthermore, the applied pressing force F is strong enough to force the wood tissue at the protruding edges 6a, 6b to collapse leading to that pressure will take effect on the adhesive in the bond line, and also cause penetration of the adhesive into the surfaces of the assembly components.

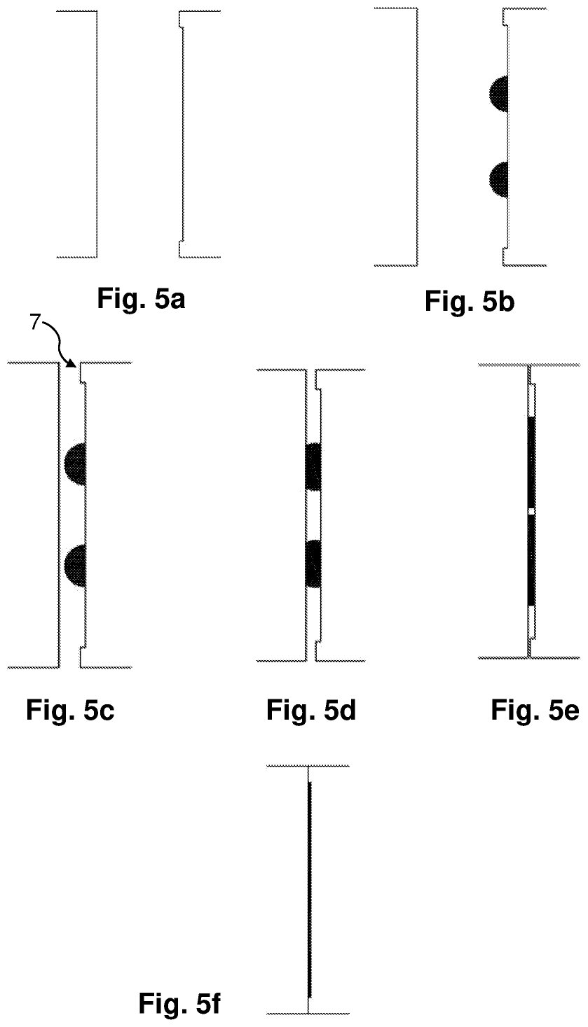

FIGS. 5a-f also illustrates in consecutive steps the gluing of two joining faces according to the method of the invention. Firstly, illustrated in FIG. 5a, two joining faces are provided, one of which comprises a groove 3. Glue 4 is applied onto at least one of the joining faces, preferably at the location of the groove 3. The two joining faces are aligned and brought to approach each other, initially resulting in that the applied adhesive is displaced and distributed inside the groove 3 (FIGS. 5d-e). Next, the two joining faces will be brought into contact, seen in FIG. 5e. The surface area whereat the two joining faces 1d; 2c contact each other upon being pressed together is defined as a “contact area” 7. At the moment when the two boards contact each other, the pressing force F will act only on said contact area. The pressing force is however dimensioned to be strong enough to cause the wooden tissue at the protruding edges to give in and collapse, as illustrated in FIG. 5f. This collapse leads to that the pressing force F will be transmitted primarily through the adhesive 4 located in the glue-line. Since the compressed wooden tissues at the periphery of the glue-line prevents the adhesive to escape/leak out, the pressure forces the adhesive to instead penetrate the tissue surrounding the glue-line.

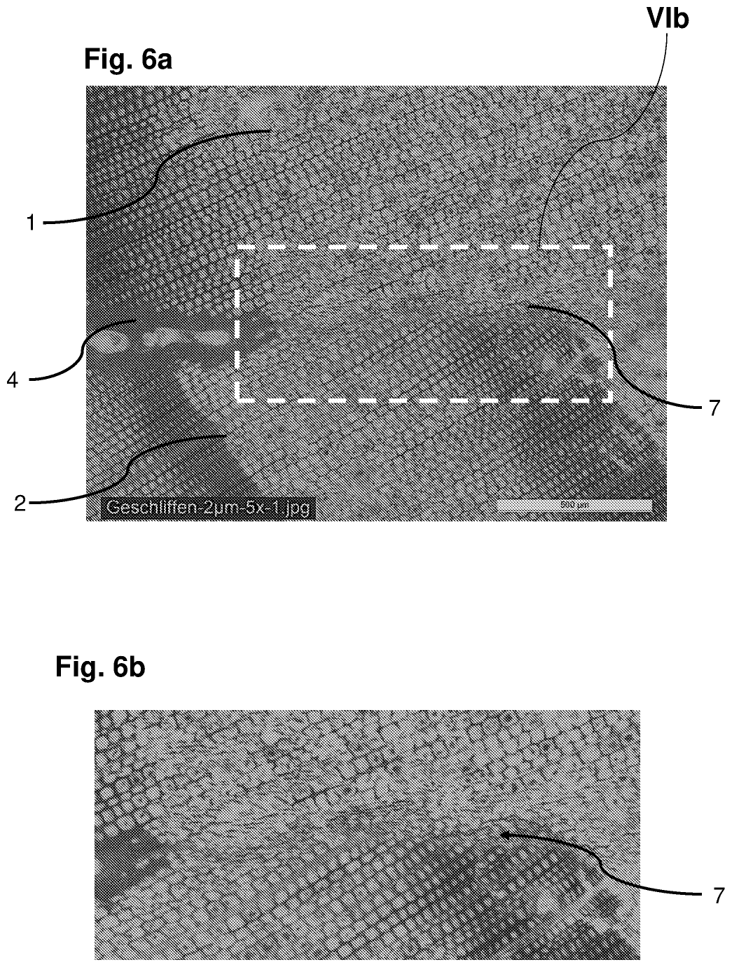

FIGS. 6a-b show microscopic, sectional views of a glueline 4 between two boards 1, 2 having been adjoined by means of the method described herein. The detailed view of FIG. 6b indicates that the wooden tissue 5 located at the contact surface 7 has collapsed as a consequence of the level of pressing force applied during the gluing step.

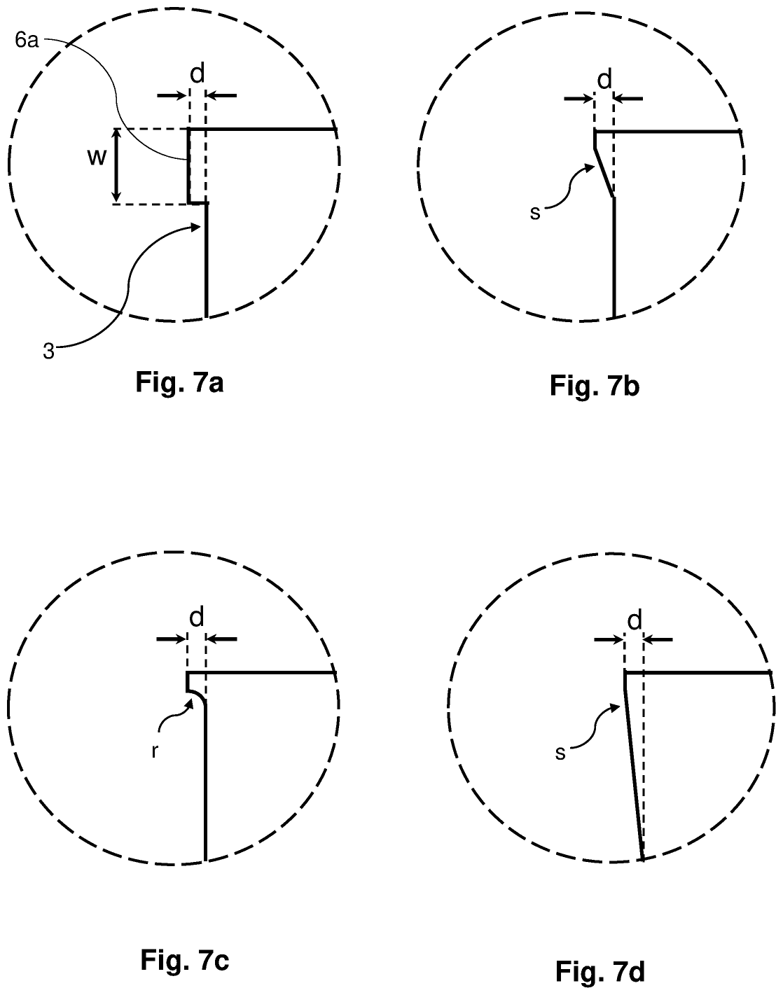

FIGS. 7a-d illustrate various conceivable outlines of profiles of a joining face comprising a groove 3. For instance, the profiles of FIGS. 7b and 7d present variants of a slanted surface s, whereas the profile of FIG. 7c has a radius r. As understood by the person skilled in the art, the profile of the groove 3 and surrounding protruding edges 6a, 6b may vary without compromising the technical function/s of the invention. Preferably, however, the maximum depth d of the groove is between 0.1-0.3 mm. This ensures that the final glueline, after pressing and curing, does not exceed the width of 0.3 mm which is the allowed maximum for load-bearing glued wooden structures.

### Example

Test Set-Up

Edge-gluing of spruce wooden boards were performed using boards with thickness T of 30 mm (thickness referring to “T” in appended FIG. 1). Adhesive was a one-component polyurethane glue.

A reference test was performed wherein wooden boards with planar joining faces were edge-glued. The boards were pressed together enough time for the adhesive to cure and stabilize.

A sample test was also performed, wherein wooden boards were edge-glued using the method according to claim 1 of the present invention. In the sample test, one of the two joining faces comprised a profile corresponding to the outline shown in appended FIG. 7a, wherein the depth d of the groove was 0.25 mm and the width w of the protruding edge was 2.0 mm. During edge-gluing of the sample, the boards were pressed together under conditions corresponding to the reference, i.e. pressure level and curing time were the same for the reference and the sample.

Result

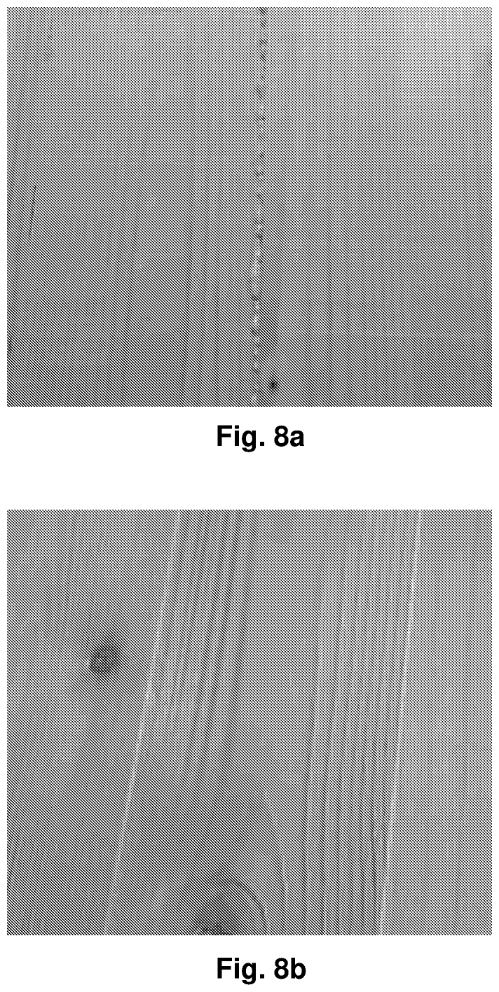

Edge-gluing of the reference resulted in clear spillage of glue which had been pressed out of the glue-line, leaving droplets of adhesive on the surface of the glued boards. This is seen in the photo of FIG. 8a wherein there is a string of glue spillage along the glue-line.

The sample comprising the profiled edge, however, presented no spillage of adhesive along its respective glue-line, seen in the photo of FIG. 8b. Tests also showed that the shear strength and delamination tendency were similar for the reference and the sample respectively.

1. A method of producing a glued wood product for use in construction, comprising the steps of:
i. providing at least two wooden pieces, each piece comprising at least one joining face;
ii. creating a groove in at least one of said joining faces, said groove being arranged between a pair of peripheral edges;
iii. applying adhesive onto at least one of the joining faces of at least a first of said two wooden pieces;
iv. arranging said first wooden piece so that the joining face which comprises the applied adhesive meets a corresponding joining face of said second wooden piece, wherein at least one of said two joining faces comprises said groove;
v. pressing the two joining faces towards each other so that the adhesive is compressed between said two wooden pieces, and maintaining said pressing for a sufficient time to bond the wooden pieces to each other;
vi. wherein an applied pressing force is strong enough to force the wood tissue to collapse at a contact area until the applied pressure force is transmitted primarily through the adhesive,
wherein said contact area is defined by the surface area wherein the two joining faces of said wooden pieces contact each other upon being pressed together.

2. The method according to claim 1, wherein:
a. said at least two wooden pieces are boards made from solid wood, each presenting a flat elongated shape and having a longitudinal direction which is substantially parallel with a principal fiber direction of the respective wooden board,
b. each of said at least two boards comprises major faces and minor faces wherein a length (L) of said major faces exceeds a width (W) of the major faces,
c. said groove is a longitudinal, lengthwise extending groove created on at least one of said faces, where said groove is arranged between a pair of peripheral, longitudinal edges,
d. said joining faces correspond to the two faces of each of the respective boards which are arranged to meet each other in step iv.

3. The method according to claim 2, wherein said groove is created on one of said minor faces of at least one of said boards.

4. The method according to claim 2, wherein said groove is created on one of said major faces of at least one of said boards.

5. The method according to claim 1, wherein the adhesive comprises isocyanate, polyvinyl acetate, urethane, polyurethane based glue, melamine-urea-formaldehyde, or phenol-resorcin-formaldehyde based adhesives.

6. The method according to claim 1, further comprising:
subjecting the at least two wooden pieces to a drying step prior to the application of adhesive so that said at least two wooden pieces, after the drying step, have a wood moisture content between 6-15% by weight.

7. The method according to claim 1, wherein said at least two wooden pieces have a wood moisture content of between 15-24% by weight.

8. The method according to claim 1, wherein the applied pressing force is between 0.6-1.5 N/mm².

9. The method according to claim 1, wherein the groove has a depth of between 0.1-0.3 mm.

10. The method according to claim 1, wherein said pair of peripheral, longitudinal edges flanging said groove presents said contact area corresponding to the surface where the two faces of said at least two wooden pieces contact each other upon being pressed together,
wherein said contact area corresponds to between 5-20% of a total horizontal area of respective face comprising said groove.

11. The method of claim 1 further comprising:
obtaining the glued wood product; and,
providing a construction element comprising the glued wood product.

12. The method of claim 11, wherein the construction element comprises a wall, roof, floor or ceiling element.
